(19) United States
(12) Patent Application Publication
(10) Pub. No.: US 2018/0028286 A1
(43) Pub. Date: Feb. 1, 2018

(54) DENTAL IMPLANT AND DENTAL IMPLANT SYSTEM

(71) Applicant: Z-Systems AG, Oensingen (CH)

(72) Inventor: Ernst Thomke, Grenchen (CH)

(21) Appl. No.: 15/662,578

(22) Filed: Jul. 28, 2017

(30) Foreign Application Priority Data
Jul. 29, 2016 (CH) 01000/16

(51) Int. Cl. A61C 8/00

(52) U.S. Cl. CPC A61C 8/0039; A61C 8/0016; A61C 8/0022; A61C 8/006; A61C 8/0089

(57) ABSTRACT

A dental implant for implantation in the jawbone for the purpose of fastening a superstructure. The implant includes an implant body that extends between a coronal and an apical end and which defines an enossal outer surface. The implant body defines a cavity that is open coronally as well as at least one exit opening from an inside to the enossal outer surface. An outer thread is shaped on the implant body. A thermoplastic element is moreover present in the solid condition and is arranged in the cavity or introducible into the cavity, wherein the thermoplastic element can be brought into an at least partly flowable condition by way of applying a pressing force, which is directed apically into the cavity, and mechanical oscillations and can be pressed through the at least one exit opening into surrounding tissue on account of the pressing force.

### BACKGROUND OF THE INVENTION

### Field of the Invention

The invention lies in the field of dental implant systems.

So-called single-part and so-called two-part implant systems belong to the dental implant systems.

### Description of Related Art

In single-part dental implant systems, the actual dental implant—which is implanted into the jawbone and serves for anchoring a functional superstructure, for example a crown, a bridge or a prosthesis—has a structure that is accessible from coronally after the implantation and on which the attachment part can be fastened in a direct manner.

In two-part dental implants, apart from the actual implant (also called “anchoring part” or “screw” if it is provided with a thread), an abutment. which is envisaged for fastening to this actual implant, is necessary. Here, the anchoring part can be designed such that it is introduced in a manner in which it is approximately flush with the bone surface (as a so-called bone-level implant) or, coronally of the bone surface, it can be provided with a region that is often widened with respect to the enossal region, which is generally provided with a thread, the first-mentioned region sometimes being termed as a “tulip” and being envisaged to reach roughly up to the gum surface. Implants with such a transgingival region are called tissue-level implants. In two-part implant systems, the region (“post”) that projects out of the gums and which serves for fastening a superstructure, thus a crown, bridge, prosthesis or the like is formed by the abutment.

Amongst other things, a dental implant that consists of a thermoplastic or thixotropic material is known from WO 02/069 817. For anchoring, this material is pressed apically into the jawbone in a linear movement amid ultrasonic vibrations, by which means it is pressed in the flowable condition into the pores of the bone and is anchored there. Towards the coronal side, it has a structure, into which an artificial tooth can be screwed. With such a system, the orientation of the implant after implantation must be defined if the artificial tooth is shaped in an anatomically meaningful manner. WO 2004/017857 also teaches implants, amongst these dental implants, concerning which an anchoring in the bone is accomplished by way of liquefaction of thermoplastic or thixotropic material and the subsequent solidification in a condition, in which the bone tissue is interpenetrated. According to WO 2004/017857, additionally to thermoplastic or thixotropic material, the implant includes a part which forms a surface region of a non-liquefiable material, said region remaining free of liquefied material even after implantation. Similarly, WO 2005/079696 also teaches such implants which however are characterised in that bone tissue is removed apically by way of the linear movement on introduction. WO 2005/079696 also teaches embodiments, in which thermoplastic or thixotropic material is brought into a cavity and after liquefaction penetrates from this cavity through exits openings into the surrounding tissue. WO 2005/079696 teaches sealingly closing this cavity after implantation. Finally, according to WO 2011/054122, surgical implants are anchored by way of thermoplastic material, which in a flowable condition is pressed into the bone, wherein the surgical implant forms a sleeve with a longitudinal opening, into which a thermoplastic element is inserted and against whose distal end the element is pushed for the liquefaction.

The anchoring of the dental implants according to WO 02/069 817, WO 2004/017857 and WO 2005/079696 is advantageous since the dental implants are anchored in a stable manner directly after implantation and the anchoring can be loaded immediately, which entails very significant advantages for the patient. In contrast to this, the state of the art requires a protracted healing-in before the dental implants can be loaded. However, the mentioned systems all have the disadvantage that the fastening of the superstructure on their base cannot be achieved or not in a manner that is satisfactory for every situation. Moreover, there are problems with the acceptance of the primary anchoring amongst the implantologists who apply such systems, since for some, at least subjectively, the strength of the anchoring does not seem to be ensured in the manner that is taught by the documents.

### SUMMARY OF THE INVENTION

It is an object of the invention to provide a dental implant and a dental implant system that overcome the disadvantages of the state of the art and which in particular permit an implantation with an immediate primary stability, without having to accept the disadvantages of the related state of the art.

According to a first aspect of the invention, a dental implant for implantation in the jawbone for the purpose of an indirect (via an abutment) or direct fastening of a superstructure is provided, said implant including:
An implant body that extends between a coronal and an apical end and which defines an enossal outer surface, wherein the implant body includes a coronally open cavity as well as at least one exit opening from an inside to the enossal outer surface,
and a thermoplastic element in the solid condition, said the thermoplastic element being arranged in the cavity or being introducible into this, wherein the thermoplastic element can be brought into an at least partly flowable condition by way of applying a pressing force, which is directed apically into the cavity, and mechanical oscillations (for example with frequencies between 10 and 100 kHz) and in this condition at least a share of the flowable material of the thermoplastic element can be pressed through the at least one exit opening into surrounding bone tissue on account of the pressing force, when the implant body is arranged in an opening in the bone tissue and the enossal outer surface is in contact with the bone tissue. The re-solidification (after renewed solidification) of the thermoplastic material after the stoppage of the vibrations effects an anchoring by way of an effected connection between interpenetrated tissue on the one hand and the implant body on the other hand via the thermoplastic material which penetrates both.

The implant body further includes an outer thread. A structure for fastening an abutment or a superstructure is present towards the coronal side.

In many embodiments, the structure for fastening the abutment or the superstructure is at least partly present in the mentioned cavity and/or is penetrated by this cavity.

For the fastening of the abutment or superstructure, this can be attached to/stuck/placed onto the dental implant by way of a movement in the axial direction, and specifically in particular in a plurality of possible orientations, for example in a finite number of possible orientations or at an arbitrary rotation angle about an axis of the dental implant.

The combination of the afore explained additional anchoring by way of the thermoplastic material, which is pressed outwards through the at least one exit opening into the surrounding tissue, with a structure for fastening an abutment or a superstructure, the structure being at least partly present in the mentioned cavity and/or being penetrated by this cavity, can be advantageous independent of whether an outer thread is present or not. For example, the implant body can be structured such that it is introduced into the bone by way of hammering in and is held there by a press fit. The additional anchoring is subsequently effected as is described above.

Hence according to a second aspect of the invention, a dental implant is provided for the implantation in the jawbone for the purse of fastening a superstructure, the implant including:
An implant body, which extends between a coronal and an apical end and which defines an enossal outer surface, wherein the implant body includes a coronally open cavity as well as at least one exit opening from an inside to the enossal outer surface,
and a thermoplastic element in the solid condition, the element being arranged in the cavity or being introducible into this, wherein the thermoplastic element can be brought into an at least partially flowable condition by way of applying a pressing force, which is directed apically into the cavity, and mechanical oscillations and in this condition at least a share of the flowable material of the thermoplastic element can be pressed through the at least one exit opening into surrounding bone tissue on account of the pressing force, when the implant body is arranged in an opening in the bone tissue and the enossal outer surface is in contact with bone tissue,
wherein the implant body includes a fastening structure for fastening an abutment or a superstructure, the fastening structure being at least partly present in the mentioned cavity and/or penetrated by this.

Possibly, the following applies to both aspects: if the dental implant belongs to a two-part implant system, then in particular the cavity, in a coronal region, can form the structure for fastening the abutment, for example by way of a fastening post of the abutment projecting into the cavity in the put-together condition.

For the purpose of fastening the abutment, the cavity can include a structure that is undercut with respect to axial directions (an inner thread or a gluing groove, which runs at least partly in the peripheral direction also belong to this structure) and that permits a securing of the abutment with regard to pulling (tension) in axial directions, for example by way of an abutment screw, by way of an insert element, to which the abutment can be fixed and/or by way of cementing, wherein the undercut results in a combined material/positive connection.

Supplementarily or alternatively to this, the cavity coronally can include a support region, in which it has a coronally enlarging, in particular continuously enlarging cross section and by way of which forces can be transmitted in the axial direction from the superstructure, possibly via the abutment, into the actual implant. Such a support region can run, for example, conically or also in a slightly concavely arcuate manner in the axial longitudinal section.

Supplementarily or alternatively, the cavity can form a rotating-in (insert/insertion) geometry structure and/or rotational lock structure, i.e. in an axial depth region it is not designed in a rotationally symmetrical manner but has, for example, an n-fold rotation symmetry, wherein n is a natural number larger than 1, in particular a natural number between 2 and 10.

In these embodiments, the cavity for the thermoplastic and for a sonotrode, by way of which the thermoplastic is pressed apically and subjected to mechanical oscillation energy, and the recess known per se for the fastening and possibly rotational locking of the abutment as well as of the rotating-in (insert/insertion) tool form a common lumen.

The option of providing the fastening structure at least partly in the cavity and possibly providing it with the mentioned features, by way of the superstructure being provided directly with a fastening post, which engages into the cavity, also exists for single-part dental implant systems.

According to a second option, the single-part dental implant system is provided with a fastening post that projects coronally from the level of the gingiva and through which a coronal section of the mentioned cavity runs.

Altogether therefore, according to the first and/or second aspect, a system arises which in a combined manner has a series of important advantages:
The anchoring capability of the classic threaded thread anchoring is possibly utilised; concerning implant bodies without an outer thread, at least an initial press fit is effected and in both cases an osseointegration after the ingrowth,
Since the abutment or the superstructure is attached/stuck on in a selectable orientation, the orientation of the implant about its axis does not need to be defined. For this reason, as the case may be, the implantologist can place the implant precisely at the desired depth on screwing in.
A direct, primary stability results due to the additional anchoring by way of the thermoplastic, by way of which primary stability undesirably large movements of the implant in the bone tissue can also be prevented even when the implant is loaded immediately after implantation.
The anchoring by way of the thermoplastic however has a certain elasticity, which permits micro-movements relative to the bone, which acts in a manner promoting bone growth.
The combination of the thread or the press fit with the anchoring by way of the thermoplastic through the exit opening allows the thermoplastic to not be brought out until the implant body is in a defined and stable position. In contrast to an introduction of the implant body by way of axial movement, thus no smearing of the thermoplastic arises, by which means for example the regions coronally of the exit openings/the exit openings remain free of thermoplastic material. By way of this, firstly the at least one exit opening can be arranged relatively deeply apically where the bone tends to be spongious and a particularly deep anchoring or penetration by the thermoplastic is possible and secondly the bone can heal well into the structures of the implant body without the danger of thermoplastic material being present between the bone and the implant body.

In particular, the at least one exit opening can be arranged in the implant body relatively far apically, for example in the lower half or even in the lower third of the enossal region (the delimitation between the enossal region and the remaining regions is a characteristic of the implant). The thread at least over a region extends coronally of the exit opening and can even be restricted to regions coronally of the exit opening.
The arrangement of the cavity through the structure for fastening an abutment or a superstructure or in a manner integrating this structure results in a synergistic effect. Thus the cavity in a coronal region can form a support and/or rotation lock (rotation fixation) for the abutment and optionally in a middle region can yet include a structure that permits an anchoring of the abutment and/or of the superstructure with regard to tension. In particular, it does not need to be necessary to completely sealingly fill the cavity before the fastening of the abutment or superstructure. The sealing effect of the thermoplastic on the one hand and the final fastening of the superstructure and possibly of the abutment on the other hand under certain circumstances is sufficient in order to prevent harmful germs from being able to come into contact with the bone through the cavity.
The anchoring by the thermoplastic can moreover have an additional sterilising effect, indeed the thermoplastic on anchoring becomes hot very locally at the location of the interface with the bone and thus ensures a germ-free environment. Since the heating is effected only very locally, despite this a significant necrosis is not to be expected in the region of the thermoplastic.

As already mentioned, in embodiments the dental implant system belongs to a two-part dental implant system, which moreover includes an abutment, i.e. an attachment part that interacts with the dental implant in order to be anchored on this and that includes a structure, for example a post, which permits the fastening of a superstructure. Two-part dental implant systems are particularly popular since they permit the actual dental implant to be able to heal in after implantation, without being subjected to loads on chewing. For this purpose, in the case of subgingival implants, the gums can be sutured over the implant after implantation; and transgingival implants are often dealt with provisorily by way of a cap. The inventive anchoring by way of a thermoplastic results in the implant being able to be loaded directly after implantation, i.e. the problems which in the state of the art lead to the preference for two-part implants do not exist for them. Despite this, the two-part design can also be advantageous with the procedure according to the invention, particularly since the abutment can be arranged at a selectable rotation angle and the aforementioned advantages concerning the absence of the necessity of a definition of the orientation of the implant therefore arise.

The following applies to single-part and two-part designs according to both aspects:

The cavity can run up to its apical end, for example essentially cylindrically, at least in an apical region.

The cavity is generally delimited by an abutting portion apically of the at least one exit opening, i.e. it is not axially continuous. The abutting portion can include an energy director structure, for example by way of it being raised towards the middle (with respect to radial directions) and for example being pointed or forming an edge.

If more than one exit opening is present—in many embodiments at least two exit openings are present—these can be arranged at the same height (have essentially the same axial position). If more than one exit opening is present, the exit opening are preferably arranged at different positions along the periphery and for example are uniformly distributed in the peripheral direction. In particular, two exit openings, which are arranged lying opposite one another, are present, and three or more exit openings that are distributed regularly in the peripheral direction are also an option.

The implant body can be ceramic or metallic. For example, it can be manufactured of a zirconium oxide ceramic, in particular of an yttrium-stabilised ceramic based on zirconium oxide. Alternatively, the implant body can also be of another material, for example of another ceramic, in particular of one based on aluminium oxide, or be of a metal, for example titanium or titanium alloy.

The enossal region of the implant body, in particular possibly the region provided with an outer thread can be roughened by way of an abrasive (material-removing) method and/or by way of a suitable coating. The healing-in of the bone is encouraged by way of this. In embodiments of the implant body as a ceramic implant body, the roughness can be present selectively only at locations of local prominences, for example on thread crests and not be present in the recesses therebetween, for example according to the teaching of WO 2011/054 119.

Further structures of a manner known per se, for example chip grooves or flutes, can be arranged at the outer side in the enossal region.

The invention also relates to a two-part dental implant system with an accordingly adapted abutment or a superstructure.

The invention moreover relates to an implantation set with a dental implant of the type described above, with an implant body and a thermoplastic element, for example according to the first and/or the second aspect. In particular, a guide sleeve can be present for the implantation, additionally to the implant body and the thermoplastic element, in order to guide the thermoplastic element on introduction and in particular to guide the sonotrode and to protect the implant body from the effects of the vibrating sonotrode.

Such a guide sleeve includes a guide lumen, which is continuous from coronal to apical (i.e. a continuous inner volume, in which and/or through which the thermoplastic element can be led). This lumen can have a cross section that is constant along the axis, i.e. be cylinder-symmetrical, even if the cavity has different regions with different cross sections. For example, it can have a circular cross section, i.e. be rotationally symmetrical about the axis. The guide lumen can be matched to a distal (apical on application) portion of the sonotrode in an exactly fitting manner, the portion being insertable into the guide sleeve, wherein the sonotrode has a slight underdimension. A flowing-back of the thermostatic material in the coronal direction towards the end of the liquefaction process can be prevented by way of such an essentially exactly fitting guidance.

The guide sleeve can optionally form a coronal widening (optionally but without the guide lumen also widening accordingly), in order to be supportable on the implant. The coronal widening can for example form a shoulder, which is supportable on a coronal end surface of the implant body, or it can be designed in a manner corresponding to an (optional) widening of the cavity, by which means the sleeve is supported in the same manner as later the abutment. Supplementarily or alternately, if the cavity of the implant includes a structure with is undercut with respect to axial directions for the purpose of fastening the abutment, the guide sleeve at the outer side can include a fastening portion that corresponds to this structure.

Additionally to the dental implant or to the dental implant system, an implantation set can include:
a rotating-in (insert/insertion) tool, which is designed to engage into a non-rotationally-symmetrical region of the cavity, in order to screw the implant into the jawbone by way of a screwing movement and/or
a sonotrode, which is shaped to engage from coronally into the cavity and to apply the mechanical oscillations as well as the pressing force.

Such a sonotrode in particular can include a distal region whose shape is matched to the guide lumen of the guide sleeve, for example in an exactly fitting manner but with a slight under-dimension.

Such a sonotrode can be coupled directly onto a device for producing mechanical oscillations, or an intermediate part between such a device and the sonotrode can be used, for example for deflecting oscillations. Such an intermediate part is disclosed for example in WO 2007/101 362.

### BRIEF DESCRIPTION OF THE DRAWINGS

Embodiment examples of the invention are hereinafter explained in more detail by way of figures. In the figures, the same reference numerals indicate the same or analogous elements. There are shown in:

FIG. 1a-1c are sectioned representations of an implant body during different stages during the implantation;

FIG. 2 shows a matching abutment;

FIG. 3a-3c shows an alternative implant body as well as an alternative cross section in the region of the rotation lock;

FIG. 4 shows an abutment matching this;

FIG. 5 shows a further implant body, again drawn in the axial longitudinal section;

FIG. 6 shows an insert element for an implant body according to FIG. 5;

FIG. 7 shows an abutment with an abutment screw;

FIG. 8 shows an implant body with an inner thread;

FIG. 9 shows an implant body of an implant for a single part system;

FIG. 10 shows an implant body without an outer thread for a two-part system;

FIG. 11 shows an implant body with an inserted guide sleeve;

FIG. 12 shows a dental implant with a guide sleeve; and

FIG. 13-15 show alternative guide sleeves.

### DETAILED DESCRIPTION OF THE INVENTION

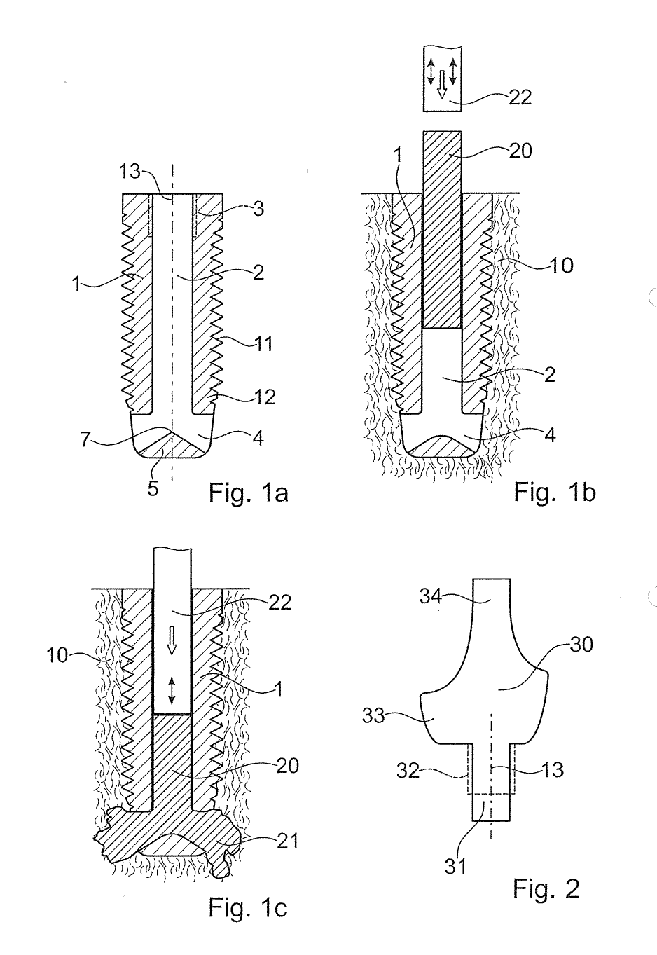

FIG. 1a in the section along the implant axis 13 (corresponding to the thread axis) shows an implant body 1 of a dental implant, the implant here forming the anchoring part of a two-part dental implant system. The embodiment represented in FIG. 1a is a tissue level dental implant, which, on implantation, is introduced so far into the bone tissue that the coronal end (represented in FIG. 1a at the upper side) lies roughly at the height of the bone crest, which is why the lateral surface can be roughened and/or coated almost up to the coronal end, in order to promote an ingrowth into the bone. The implant body 1 includes an outer thread 11, which here extends practically over the complete length almost up to the coronal end. Optional, apical chip grooves 12 are moreover present at the outer side.

The implant body as a whole, with the exception of the thread recesses and the chip grooves, has an essentially cylindrical shape that merges apically into slightly tapering shape. The outer thread 11 has a non-constant thread depth and can be designed in a self-tapping manner.

The implant body 1 is manufactured for example of a zirconium oxide ceramic, in particular of an yttrium-stabilised ceramic based on zirconium oxide. Generally, the teaching, which is described here by way of embodiment examples, however also applies to implant bodies of another material, for example of another ceramic, in particular based on aluminium oxide, or of a metal, for example titanium or a titanium alloy.

A cavity 2, which is open to the coronal end, extends almost over the complete length of the implant and is delimited apically by an abutting portion 5 extends apically from the coronal end parallel to the axis 13. Two exit openings 4, which lie opposite one another, are formed radially outwards from the cavity 2 towards the outer surface (lateral surface). The abutting portion 5 is slighted pointed towards the middle, so that an energy director 7 whose function is yet explained hereinafter is formed.

Towards the coronal end, the cavity can include a widening 3, which in FIG. 1a is only represented in a dashed manner and which is not rotationally symmetrical about the axis 13, so that a matchingly designed rotating-in tool (insert/insertion tool) can engage into it, in order rotate the implant body into the bone tissue by way of the outer thread 16—preferably after carrying out a pre-drilling. With regard to its cross section, the cavity in the region of the widening 3 in particular can have an n-fold symmetry, for example 3-fold, 4-fold, 5-fold, 6-fold, 7-fold or 8-fold symmetry. In cross section it can have the shape for example of an n-fold polygon with rounded corners; and other cross-sectional shapes, for example a Torx-like shape are also possible. The cavity can be approximately cylindrical, i.e. run in a rotationally symmetrical manner along the axis, each in the region of the widening 3 as well as apically of this, wherein a slightly apically tapering shape is not ruled out and wherein, as is to be seen in the following examples, further, possibly also non-cylindrical portions can also be present.

FIG. 1b shows the implant body 1 screwed into bone tissue 10, together with the thermoplastic element 20, which can be introduced from coronally into the cavity 2. A sonotrode 22 with a cross section that is adapted to the cavity is also indicated. The cross section of the sonotrode 22 is such that this is insertable into the cavity 2 essentially without any force effort when this is free.

The thermoplastic element 20 is designed in an essentially pin-like manner, for example cylindrically, with a cross section that is matched to the cavity and in particular to its apical region. The thermoplastic element can be designed in particular in a circularly cylindrical manner.

As is shown in FIG. 1c, for the anchoring, which is additional to the anchoring by way of the screwing-in, the thermoplastic element 20 is pressed apically against the abutting portion 5 by way of the sonotrode 20 whilst the sonotrode is subjected to mechanical oscillations, by which means the thermoplastic material of the thermoplastic element 29 in contact with the abutting portion 5 is heated, until it becomes flowable and is displaced outwards through the exit openings 4 on account of the pressing pressure and is pressed into the structures of the bone tissue. Here, the effect of the energy director 7 can be such that the energy absorption initially primarily takes place in contact with this, by which means the thermoplastic material is firstly heated there most of all. Since the internal fiction of the thermoplastic material is much higher when this has a higher temperature (for example with an amorphous thermoplastic when it lies above the glass transition temperature), the main focus of the energy absorption also subsequently takes place at the apical end, by which means it is ensured that the liquefaction is in the region of the exit openings 4.

The interface between the sonotrode 22 and the thermoplastic 20 is continuously displaced apically during this process, by which means the coronal region of the cavity also remains essentially free of thermoplastic material and after the removal of the sonotrode can serve for the insertion of the fastening post of the abutment. Depending on the oscillation conditions and the length of the thermoplastic element 20, one can even envisage the coronal region of the cavity, for example in particular the region of the widening (and in the subsequent embodiments also in regions that serve for the anchoring apically of this) never coming into contact with the liquefied, thermoplastic material.

After a re-solidification subsequent to the energy input having been stopped, the liquefied shares 21 of the thermoplastic material, which are pressed into the bone, ensure an additional anchoring of the implant body 1 and thus of the complete implant in the bone tissue 10 and secure this in particular against being inadvertently screwed out or shaken out. This anchoring ensures an adequate primary stability during the healing-in phase.

According to a first possibility, the thermoplastic material of the thermoplastic element can be resorbable and thus be reabsorbed by the body after a few months when the implant is healed-in, whereupon the bone can grow through the exit openings 4 into the inside of the implant body 1 and therefore contribute further to the anchoring. Useable, resorbable polymers are, for example, polylactides, which are also commercially available for applications in surgery.

According to a second possibility, the thermoplastic element can be non-resorbable. The share of thermoplastic material with regard to the anchoring then remains the same. A useable, non-resorbable polymer is for example PMMA or a polyamide.

Apart from the fastening post 31, the abutment 30 represented in FIG. 2 includes a coronal post 34 for fastening a superstructure. A transgingival region 33, which is adapted, for example, to the expected course of the gingiva, is formed apically of this coronal post. The shapes of such a transgingival region 33 as well as of the post 34 including its angle to the fastening post 31 and consequently to the axis 13 are adapted to the specific requirements and depend on where the implant is or has been placed in the jaw. In particular, an implantation set with at least one implant can include several different abutments for different implantation situations.

A rotation-lock structure 32 can be formed on the fastening post 31. Such a rotation-lock structure 32 has an outer structure, which fits into the region of the implant which is not rotationally symmetrical, and fixes the rotation angle of the abutment relative to the jawbone. Very generally, the abutment in particular can be placed onto/attached to the implanted implant by way of a movement in the axial direction, without a substantial rotation.

In the example according to FIGS. 1 and 2, a fastening of the abutment to the implant, in particular to the implant body is effected by cementing as is known per se. The applied cement can also be used to fill free regions of the cavity apically of the region, into which the fastening post 31 penetrates.

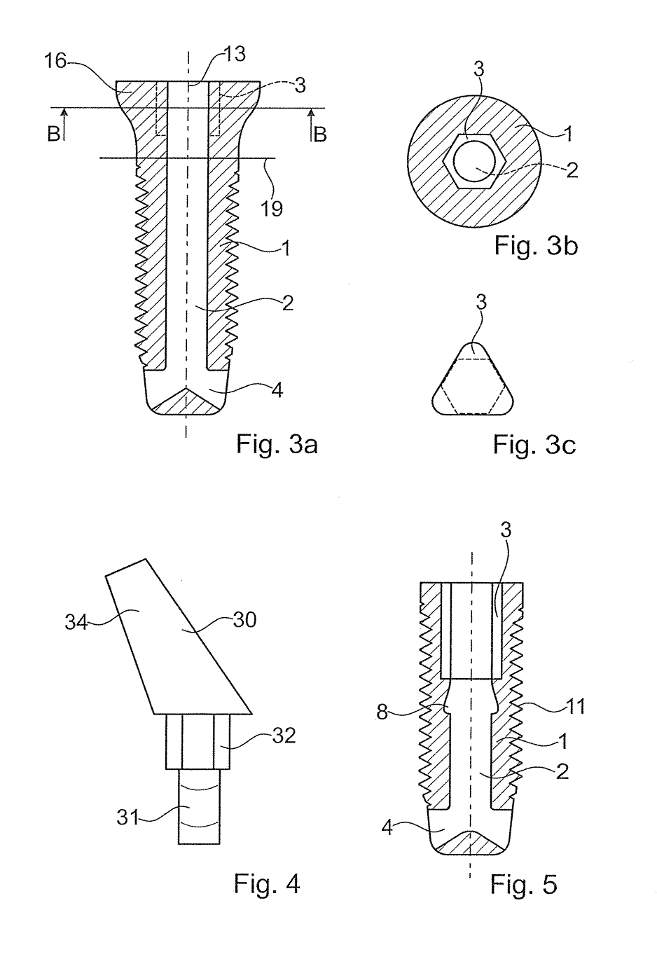

The embodiment of FIGS. 3a and 3b (in which figures the thermoplastic element of the implant is not represented) as well as of FIG. 4 differs from that of FIGS. 1 and 2 in that the implant of dental implant system, the implant system still being of two parts, is a designed transgingivally, i.e. is a tissue level implant.

For this purpose, coronally of the enossal region, which is provided with an outer thread 11 and under certain circumstances is roughened and/or coated, it includes a transgingival region (line 19 shows the approximate level of the bone ridge), in which the implant projects slightly here. FIG. 3b, which very schematically shows a representation of the implant sectioned along the plane B-B in FIG. 3a, shows the widening 3 as a being hexagonal in cross section, by which means the abutment with the corresponding hexagonal rotation-lock structure 32 can be inserted in six different relative orientations.

In the represented embodiment, the abutment is moreover drawn with an angled, coronal post 34, and the abutment can be designed in a manner adapted to the position on the jaw and to the desired tooth position, independently of the design of the implant as a subgingival or transgingival implant and independently of the type of fastening.

In all embodiments, supplementarily or alternatively to a non-rotationally-symmetrical region (rotating-in (insertion) geometry region and/or rotation-lock region), the cavity 2 in the coronal region can optionally also include a support region, which has a diameter which increases slightly in the coronal direction and by way of which forces can be transmitted in the axial direction from the superstructure, possibly via the abutment, into the actual implant. Such a support region can, for example, be designed conically and, for example, lie coronally of the insert geometry region. Possible embodiments of regions of a coronally open cavity in the implant and its manners of functioning in the context of an interaction with a rotating-in (insert/insertion) tool and of the fastening of the abutment are described, for example, in the Swiss patent application 01 786/15, which is expressly incorporated herein by reference. The procedure of the present invention renders it possible to combine the functions of the recess, which is described therein, and generally of recesses for fastening an abutment or superstructure, with the function of the cavity for receiving the thermoplastic element and for introducing the sonotrode for the purpose of subjection to mechanical energy.

FIG. 3c shows a cross section of the widening 3, which is an alternative to that of FIG. 3b, in the rotation-lock region, the widening in particular being able to be advantageous with implant bodies of ceramic material, since it renders possible an improved distribution of the forces that are exerted on rotating-in (insertion) by the rotating-in (insert/insertion) tool. The dotted contour in FIG. 3c illustrates the fact that a 2*-fold (or 3*n-fold etc.) structure of an abutment can interact in such an n-fold, here three-fold structure, in order to permit a greater number of relative orientations.

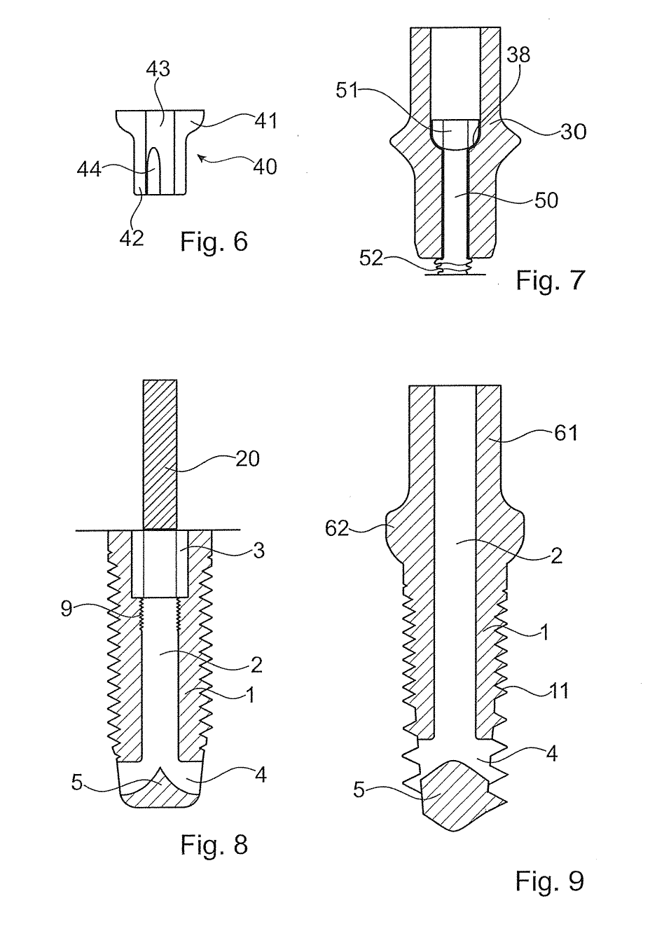

FIG. 5 shows a further design of an implant body 1, as is useful in particular for ceramic implant bodies. In the coronal region, the cavity forms a widening 3 of the type mentioned above with a non-rotationally-symmetrical cross section. In contrast to the drawn embodiment, a support region of the mentioned type can additionally also be formed, for example coronally of the non-rotationally-symmetrical region, as described in the Swiss patent application 01 786/15. The recess moreover forms an undercut insert element region, which here widens slightly conically towards the apical side. This serves for the anchoring of the insert element, which is secured with respect to axial tension, as drawn for example in FIG. 6.

Such an insert element can be introduced with its apical end into the undercut insert element region by way of its apical end being able to be deformed on account of slots 44, which separate several segments 42 from one another. A through-opening 43 with an inner thread function, i.e. with an inner tread or at least with an inwardly projecting edge, which cooperates with an outer thread runs in the axial direction and extends centrally. A coronal head region 42 is not rotationally symmetrical but in its outer contour is adapted to the geometry of the non-rotationally-symmetrical region so that the insert element can be inserted in a manner secured against rotation. The segments can be fixed in the spread condition by way of screwing in an abutment screw (or also a corresponding screw of a rotating-in (insertion) tool), by which means the insert element and accordingly the screwed-in abutment screw or tool screw are secured against tension in the coronal direction on account of the undercut.

FIG. 7 schematically shows an abutment 30 with an abutment screw 50 with an abutment screw thread 52 and with a continuous opening for the abutment screw, wherein a head of the screw in the screwed-in condition of the abutment screw is pressed against a shoulder 38, which is formed in the continuous opening, and thus fixes the abutment with respect to the implant. Such a design serves, for example, for fastening the abutment, by way of the interaction of the abutment screw thread 52 with the through-opening 43 of the insert element 40. Alternatively, the abutment screw can also be fixedly screwed directly on the implant, which is known per se, particularly for metallic implants, but is also not ruled out for ceramic implants with a corresponding strength.

FIG. 8 schematically shows a corresponding implant of a two-part implant system (with the example of a sub-gingival implant). The cavity 2 includes a region with an inner thread 9, here between the widening 3 and the apical cylindrical region, which for example is also present in the other embodiments and drawn there and which runs out into the exit openings 4.

FIG. 9 shows an implant body 1 of a dental implant for a single-part dental implant system. The thermoplastic 20 is not drawn, but can be designed analogously to the thermoplastic elements for two-part systems. The dental implant, apart from the features described by way of the above embodiments, includes a coronal post 61 for fastening a superstructure as well as a projection 62 for supporting the superstructure and/or for the compression of the gums. The cavity 2 extends axially through the post 61.

With embodiments for single part dental implant systems with an angulated post, the cavity can also merely extend through a part of the post.

Optionally, in the case of a single part dental implant system, the implantologist or dentist can fill the cavity from the coronal side with a suitable filler, for example with a cement, after the additional anchoring by way of the thermoplastic material and before the fastening of the superstructure.

A further feature of the implant according to FIG. 9 can also be realised in any other embodiment of the invention independently of whether the implant system is of one part or two parts: whereas the implant body of the previously discussed embodiments are all essentially cylindrical in the enossal region, this is not the case with FIG. 9. In contrast, the implant body is essentially conical with an apically tapering outer contour.

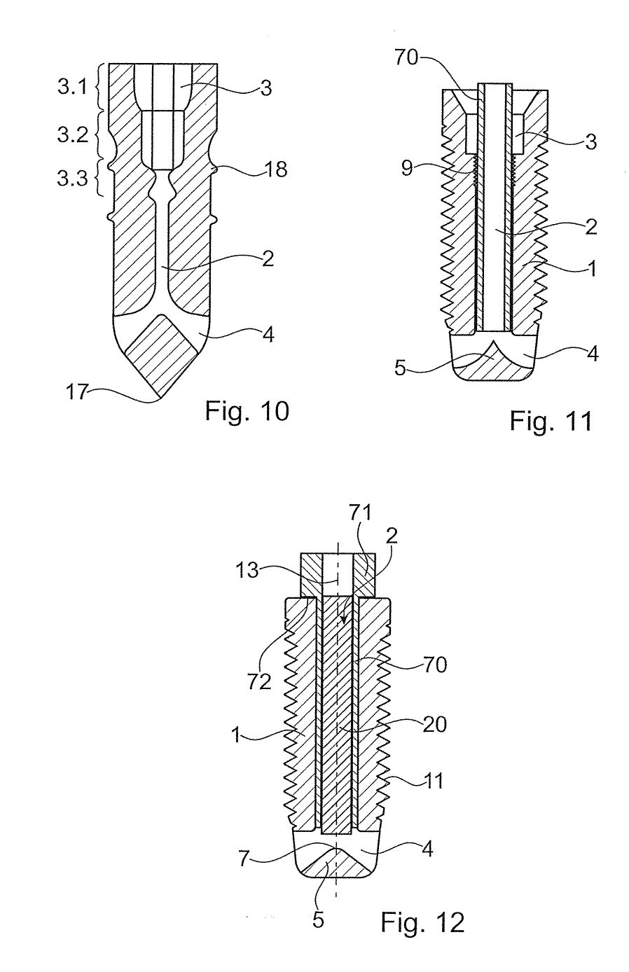

FIG. 10 shows an implant body, here for a two part implant system that has no outer thread. Instead of this, in the represented embodiment example the implant is slightly tapered apically (tip 17) and includes slightly projecting ribs 18, which run in the peripheral direction in the drawn embodiment example. Supplementarily or alternatively, axially running ribs are also considered and these can moreover project somewhat further than the ribs running in the peripheral direction.

A structure for fastening the abutment, the structure being formed in the cavity 2 is represented once again in the shown example. The widening 3 here forms three regions: a support region 3.1, a rotation-lock region 3.2 with a structure that is not rotationally symmetrical about the axis, and an undercut region 3.3, here for fastening an insert element of the type described above.

All three regions are optional. The rotation-lock region with regard to this implant does not serve for the engagement of a rotating-in (insertion) tool, since such is not necessary at all. A rotation-lock region can be useful despite this, particularly if the rotation-lock effect of the pressing in the support region 3.1, between the implant and the abutment (or superstructure), is not sufficient or such a support region is not present; this is analogously the case with bonded (cemented) systems if the rotation-lock effect of the bonding connection is not sufficient.

FIG. 11 shows an implant concerning which the cavity 2 is designed similarly as with the implant according to FIG. 10 with an inserted guide sleeve 70. Such a guide sleeve consists of a material or materials that is/are not liquefiable under the conditions prevailing during the implantation—for example of a metal or of a duroplastic plastic or of a plastic with a very high liquefaction temperature, for example PEEK. The thermoplastic element and the distal end of the sonotrode can be led in the inside of the guide sleeve 70. As is drawn, the guide sleeve can extend essentially over the complete axial length of the cavity, or for example can also only protect a coronal region of this cavity, for example the region of the widening 3, which is yet illustrated hereafter.

By way of another embodiment of an implant body, FIG. 12 illustrates that the guide sleeve can include a coronal widening, which here forms a shoulder 72, by way of which the guide sleeve can be supported on the implant body, by which means the axial definition is defined for the implantologist on insertion and the portion apically of the support is prevented from being able to cover the exit openings 4.

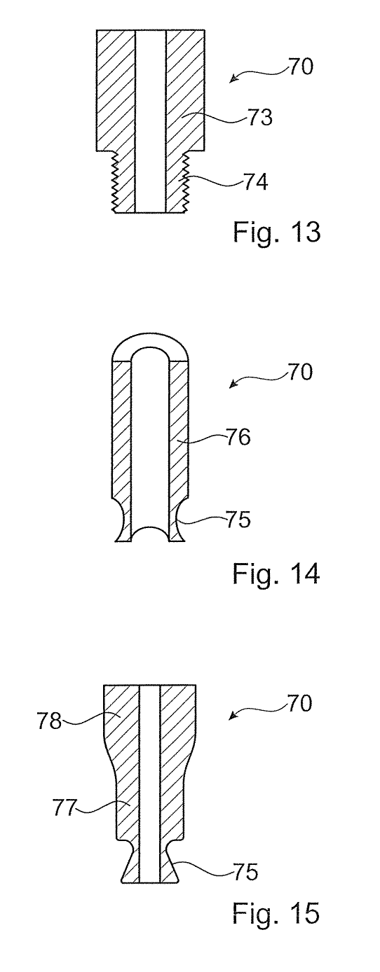

FIG. 13 shows a variant of the guide sleeve 70, which combines two optional features that are independent of one another:
Firstly, the guide sleeve includes an outer thread 74 as an example of an undercut structure, the structure interacting with a corresponding structure (here: inner thread) of the implant body, in order to fix the guide sleeve relative to the implant body with respect to axial directions.
Secondly, the axial extension of the guide sleeve is limited to the region of the widening of the cavity, thus in particular protects this widening at leads in the region of this. The thermoplastic element and/or the sonotrode can be led apically of the guide sleeve, directly through the cavity.

In the example of FIG. 13, the guide sleeve in particular matches an implant body of the type that is illustrated in FIG. 8 or also of the type illustrated in FIG. 5 (then with an insert element), which is why this body also forms a widening 73 coronally of the undercut structure (outer thread 74), by way of which widening it is additionally supported, wherein this winding limits the screw-in movement and thus protects the inner thread of the implant body on introducing the guide sleeve. The cross section of the widening 73 can be matched in a suitable manner to the cross section of the widening 3 of the cavity, wherein the rotation-lock structure would of course not be present in the case of a sleeve to be screwed in.

The variant of the guide sleeve 70 according to FIG. 14 is matched to an implant body of the type represented in FIG. 5 (without insert element) and includes an undercut structure 75 that can be clicked in, next to a widened region 76. This variant too—as with that one which is described above—differing from that which is drawn, can optionally be led further apically of the undercut structure and extend essentially over the complete region up to the exit openings.

This also applies to the variant according to FIG. 15, which otherwise matched to a cavity as drawn in FIG. 10 includes three regions, an undercut structure 75, a middle region 77 and a coronal support region 78.

With guide sleeves, which can be introduced into the cavity by way of a mere axial movement as is the case with the embodiments according to FIG. 14 and according to FIG. 15, optionally a respective region (for example the middle region 77 in FIG. 15) in its outer shape can be matched to a rotating-in (insert/insertion) geometry of the implant body and also be secured against rotation.

1. A dental implant for implantation in the jawbone, comprising:
an implant body that extends between a coronal and an apical end and which defines an enossal outer surface,
wherein the implant body defines a coronally open cavity as well as at least one exit opening from an inside to the enossal outer surface,
and a thermoplastic element in the solid condition, said thermoplastic element being arranged in the cavity or being introducible into said cavity,
wherein the thermoplastic element can be brought into an at least partly flowable condition by way of applying a pressing force, which is directed apically into the cavity, and mechanical oscillations and in this condition at least a share of the flowable material of the thermoplastic element can be pressed through the at least one exit opening into surrounding bone tissue on account of the pressing force, when the implant body is arranged in an opening in the bone tissue and the enossal outer surface is in contact with the bone tissue,
wherein the implant body comprise an outer thread as well as a fastening structure for fastening an abutment or a superstructure.

2. The dental implant according to claim 1, wherein the exit opening is arranged apically of at least a part of the outer thread.

3. The dental implant according to claim 1, wherein the fastening structure is at least partly present in the cavity and/or is penetrated by the cavity.

4. A dental implant for implantation in a jawbone, comprising:
an implant body that extends between a coronal and an apical end and which defines an enossal outer surface,
wherein the implant body comprises a coronally open cavity as well as at least one exit opening from an inside to the enossal outer surface, and
a thermoplastic element in the solid condition, said element being arranged in the cavity or being introducible into said cavity,
wherein the thermoplastic element can be brought into an at least partially flowable condition by way of applying a pressing force, which is directed apically into the cavity, and mechanical oscillations and in this condition at least a share of the flowable material of the thermoplastic element can be pressed through the at least one exit opening into surrounding bone tissue on account of the pressing force, when the implant body is arranged in an opening in the bone tissue and the enossal outer surface is in contact with bone tissue,
wherein the implant body comprises a fastening structure for fastening an abutment or a superstructure, said fastening structure being at least partly present in the cavity and/or being penetrated by the cavity.

5. The dental implant according to claim 4, which is designed as part of a two-part implant system, wherein the fastening structure is designed for fastening an abutment and is formed at least partly in the cavity such that the fastening presupposes the engagement of a fastening post of the abutment into the cavity.

6. The dental implant according to claim 3, wherein for the purpose of fastening an abutment or a superstructure, the cavity comprises a structure that is undercut with respect to axial directions and which permits a securing of the abutment or superstructure with regard to pull in axial directions.

7. The dental implant according to claim 3, wherein the cavity forms a support region, in which it has a coronally enlarging cross section.

8. The dental implant according to claim 3, wherein the cavity forms a rotating-in geometry region and/or rotation-lock region, in which it is not rotationally symmetrical with respect to rotations about a cavity axis.

9. The dental implant according to claim 1, wherein the mentioned fastening structure is formed such that the abutment or the superstructure can be attached onto the dental implant by way of a movement in the axial direction.

10. The dental implant according to claim 9, wherein the abutment or the superstructure can be attached in a plurality of possible orientations.

11. The dental implant according to claim 10, wherein the fastening structure defines a finite number of possible orientations and a rotating-in geometry for a rotating-in tool.

12. The dental implant according to claim 1, wherein the cavity is delimited apically of the exit opening by an abutting portion.

13. The dental implant according to claim 12, wherein the abutting portion forms an energy director.

14. A dental implant system, comprising a dental implant according to claim 1 as well as an abutment or superstructure with a fastening portion, which is adapted to the fastening structure.

15. An implantation set, comprising
a dental implant, according to claim 1, with:
an implant body that extends between a coronal and an apical end and which defines an enossal outer surface, wherein the implant body defines a cavity that is open coronally as well as at least one exit opening from an inside to the enossal outer surface, and
a thermoplastic element in the solid condition, said thermoplastic element being arranged in the cavity or being introducible into this, wherein the thermoplastic element can be brought into an at least partly flowable condition by way of applying a pressing force, which is directed apically into the cavity, and mechanical oscillations and in this condition at least a share of the flowable material of the thermoplastic element can be pressed through the at least one exit opening into surrounding tissue on account of the pressing force, when the implant body is arranged in an opening in the bone tissue and the enossal outer surface is in contact with the bone tissue,
as well as a guide sleeve, which can be introduced into the cavity or is arranged in the cavity and which at least regionally surrounds the thermoplastic element, which is arranged in the cavity or which is introduced into the cavity.

16. The implantation set according to claim 15, wherein the guide sleeve forms a coronal widening by way of which it can be supported on the implant.

17. The implantation set according to claim 15, wherein the guide sleeve comprises an undercut structure in order to engage into a corresponding undercut structure of the implant body.

18. The implantation set according to claim 15, comprising a rotating-in tool which that is designed to engage into a non-rotationally-symmetrical region of the cavity in order to screw the implant body into the jawbone by way of a screwing movement.

19. The implantation set according to claim 15, comprising a sonotrode that is shaped to engage coronally into the cavity and to apply the mechanical oscillations as well as the pressing force.

20. The implantation set according to claim 19, wherein the sonotrode comprises a distal region whose shape is matched to the guide sleeve.
